(19) United States
(12) Patent Application Publication
(10) Pub. No.: US 2009/0112601 A1
(43) Pub. Date: Apr. 30, 2009

(54) Talking Glove

(76) Inventor: Larry Don Fullmer, Medford, OR (US)

Correspondence Address: Larry Don Fullmer, 1674 Rolling Meadows Lane, Medford, OR, 97504, US

(21) Appl. No.: 11/924,404

(22) Filed: Oct. 25, 2007

(51) Int. Cl. G10L 11/00; G06F 17/00

(52) U.S. Cl. 704/271; 2/159; 700/94; 704/E11.001

(57) ABSTRACT

A human interface device for assisting the verbally challenged to record custom messages and play back the custom and pre-recorded messages through a sequence of simple finger movements. A data glove containing Hall Effect and Bend Resistor is warn by the user and connected to the Voice Module. The data glove is designed to capture and translate the sequence of finger movements into actions, then transmits the actions to the Voice Module. When a pause is sensed in the actions, the Voice Module links these actions to the custom or pre-recorded messages. These messages are then played on the Voice Module allowing people in close proximity to hear. A Remote Voice Monitor may also be wirelessly connected to the Voice Module to allow remote monitoring.

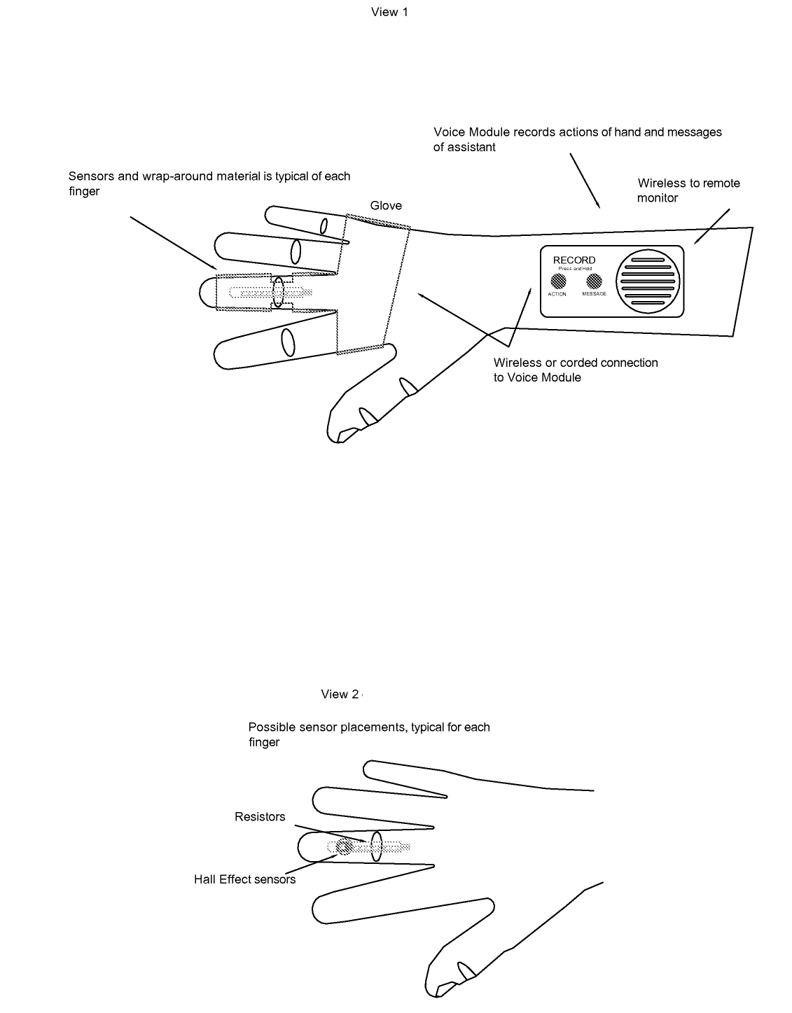

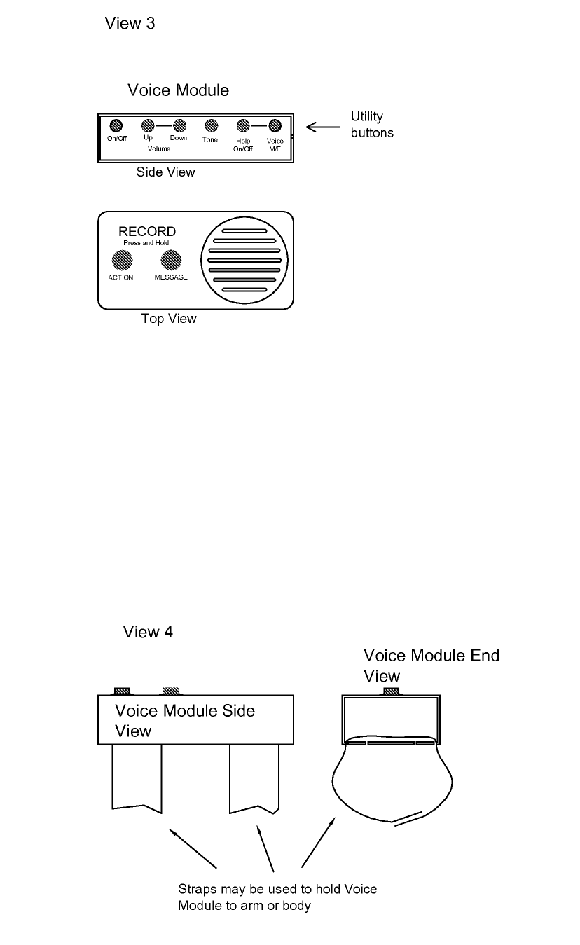

### CROSS-REFERENCE TO RELATED APPLICATION

Not Applicable

### STATEMENT REGARDING FEDERALLY SPONSORED RESEARCH OF DEVELOPMENT

Not Applicable

### REFERENCE TO SEQUENCE LISTING, OR A COMPUTER PROGRAM LISTING COMPACT DISC

Not Applicable

### BACKGROUND OF THE INVENTION

Data gloves of various types are used to connect into to a personal computer (PC). Complicated PC software is used to interpret sensor inputs from the data gloves to drive such applications as simulators and robot control.

A relative to the inventor has been rendered verbally challenged due to a stroke. The inventor found a way to use a specifically designed data glove and electronic hardware to improve the ability for verbally challenged people to communicate through speech. This design does not need to be connected to a PC to operate.

### BRIEF SUMMARY OF THE INVENTION

The Talking Glove interprets sensor inputs from a specifically designed data glove using firmware to translate hand and finger movements to firmware code and linking the to custom messages. This allows people that are verbally challenged to “speak” short phrases or long sentences, using only a few simple movements of the hand.

### BRIEF DESCRIPTION OF THE DRAWING

View 1 of 4 shows a portion of the data glove showing the wrap-around material used in the glove. It also shows the Bend Resistor sensor above the knuckle. This placement is typical of the four fingers. This view also shows the Voice Module placed in the forearm of the user.

View 2 of 4 shows the approximate placement of the Hall Effect sensor on the inside of the finger with respect to the placement of the Bend Resistor sensor on the finger of the user. This placement is typical of the four fingers.

View 3 of 4 shows a top and side view of the Voice Module indicating the placement of some of the buttons used in this invention.

View 4 of 4 shows one possible method of attaching the Voice Module to the forearm of the user using a soft strapping material and fasteners.

### DETAILED DESCRIPTION OF THE INVENTION

The Talking Glove assists people that are verbally challenged.

The Talking Glove product is stand-alone and does not need a personal computer to operate. A personal computer may be connected to the Talking Glove to change settings and upload/download information to the modules.

The Talking Glove consists of 3 parts, the Data Glove the Voice Module and a Remote Module.
The Data Glove
   The Data Glove includes Hall Effect sensors and resistive sensors on each finger and a small magnet on the thumb. When the thumb touches various locations of the fingers, or when the fingers bend, the sensors and associated electronics conditions the signals and sends the signals to microcontrollers. The firmware embedded in the microcontrollers converts the movement into motions. One or several motions make up an action.
   The Data Glove may not contain a microcontroller. A multi-wired connector would connect the glove sensors directly to the voice module. The glove may contain a microcontroller to sense and translate the actions and sends signals to the microcontroller on the voice module. The signals may be sent to the voice module through a connector and wires or wirelessly.
   The Data Glove is warn on the hand and fingers of the person, while the voice module is warn on the arm or place on other covenant locations of the body.
The Voice Module
   The Voice Module may be connected wirelessly or wired to the Data Glove. The Voice Module consists of the necessary electronics to store pre-recorded messages, record custom messages, play back the pre-recorded and custom messages, and to customize the functions of the Voice Module.
The Remote Module
   The Remote Module is connected wirelessly or wired to the Voice Module or Data Glove and contains the electronics to remotely monitor the messages played on the Voice Module.

I claim:

1. A human interface device used to link hand and finger movements to pre-recorded or custom messages that are broadcast from a stand-alone electronic device comprising:
1.1 a Data Glove
1.2 a Voice Module
1.3 a Remote Voice Monitor.

2. The device of claim 1 wherein the Data Glove is made of cloth and plastic materials with channels over the knuckle of the 4 fingers allowing the Bend Resistor to function properly.

3. The device of claim 1 wherein the Data Glove contains Hall Effect sensors attached to the inside of the 4 fingers and a magnet on the thumb that, when the thumb is drawn close to any finger, the Hall Effect sensors produce a signal.

4. The device of claim 1 wherein the Data Glove contains electronics circuitry that translates the Hall Effect Bend Resistor signals into specific actions and send those actions via wireless or wire connection to the Voice Module.

5. The device of claim 1 wherein the Voice Module contains pre-recorded help and courtesy messages such as, “one”, “two”, “please”, and “thank you” stored in computer memory devices.

6. The device of claim 1 wherein the Voice Module contains a microcontroller, microphone, analog-to-digital converter, digital-to-analog converter, power amplifier and a speaker to record custom messages and to play the custom and the pre-recorded messages over the speaker.

7. The device of claim 1 wherein the Voice Module contains 2 record buttons and several utility buttons. The record buttons are use to record actions and custom voice messages and link the recorded actions to the recorded messages.

8. The device of claim 1 wherein the Voice Module responds to any sequence of actions from the Data Glove, links the sequence of actions to the messages, and plays the messages over the speaker.

9. The device of claim 1 wherein the Remote Voice Monitor is connected via wireless or wire connection to the Voice Module and is only a listening device that receives the custom and pre-recorded messages that is played on the Voice Module.
